(19) United States
(12) Patent Application Publication
(10) Pub. No.: US 2013/0241969 A1
(43) Pub. Date: Sep. 19, 2013

(54) DISPLAY SYSTEM, DISPLAY PROGRAM, AND DISPLAY METHOD

(71) Applicant: SEIKO EPSON CORPORATION, Tokyo (JP)

(72) Inventor: Masaki ISHIKAWA, Kunitachi-shi (JP)

(73) Assignee: SEIKO EPSON CORPORATION, Tokyo (JP)

(21) Appl. No.: 13/791,513

(22) Filed: Mar. 8, 2013

(30) Foreign Application Priority Data
Mar. 16, 2012 (JP) 2012-060225
Dec. 27, 2012 (JP) 2012-285346

(51) Int. Cl. G09G 5/10

(52) U.S. Cl. CPC G09G 5/10
USPC 345/690

(57) ABSTRACT

A display system according to an embodiment of the invention generates display image data having the luminance difference between the outer edge pixel of a figure of input image data and the outer peripheral pixel located outside the figure and adjacent to the outer edge pixel set so that the larger the color difference between the outer edge pixel and the outer peripheral pixel is, or the larger the saturation of the outer edge pixel is, the larger the luminance difference between the outer edge pixel and the outer peripheral pixel is, and performs display using the display image data.

The entire disclosure of Japan Patent Application No. 2012-60225, filed Mar. 16, 2012 and No. 2012-285346, filed Dec. 27, 2012 is expressly incorporated by reference herein.

### BACKGROUND

1. Technical Field

Several aspects of the present invention relates to a display system, a display program, and a display method.

2. Related Art

In recent years, development of an electronic paper, which is capable of electrically rewriting the display content while adopting advantages of a hard copy represented by a paper medium, such as an electrophoretic display (EPD) has been in progress. EPD has higher visibility compared to a cathode ray tube (CRT) or a liquid crystal display (LCD) used as a display device for present personal computers and so on to thereby be eye-friendly, and it can be bent to be superior in portability.

Most of the electronic papers in practical use display an image with two colors of white and black. Therefore, in order to display a color image with the electronic papers, conversion into a binary image with white and black colors is required.

In order to output the color image with a monochrome printer, a variety of techniques for converting the color image into a binary image with white and black colors are disclosed (JP-A-2009-5331).

In the case of converting the color image into the binary image with white and black colors, there are some cases in which characters expressed in particular in halftone are difficult to recognize visually.

### SUMMARY

An advantage of some aspects of the invention is to provide a display system, a display program, and a display method with which it is easy to visually recognize the characters or the like expressed in halftone.

A display system according to one aspect of the invention is a display system adapted to display an image including a first image data generation section adapted to perform a first image data generation process of generating first image data from data of the image, a second image data generation section adapted to generate second image data obtained by performing area coverage modulation on the first image data, and a display processing section adapted to perform a process of making an electronic paper display the image based on the second image data, wherein assuming that an outer edge pixel is a pixel in an outer edge of a figure included in the data of the image, and an outer peripheral pixel is a pixel located outside the figure and adjacent to the outer edge pixel, the first image data includes the outer edge pixel having a luminance value set to a value by a predetermined value larger than the data of the image, and the larger the color difference between the outer edge pixel and the outer peripheral pixel in the data of the image is, or the larger the saturation of the outer edge pixel in the display image data is, the larger the predetermined value is.

In the display system according to the one aspect of the invention described above, it is preferable that the first image data generation section performs the first image data generation process if a luminance difference calculated in the outer edge pixel in the data of the image is smaller than a reference value.

A display system according to another aspect of the invention is a display system adapted to display an image including a first image data generation section adapted to perform a first image data generation process of generating first image data from data of the image, a second image data generation section adapted to generate second image data obtained by performing area coverage modulation on the first image data, and a display processing section adapted to perform a process of making an electronic paper display the image based on the second image data, wherein the first image data generation process is a process of increasing a luminance value in a pixel of the data of the image as much as a predetermined value if a calculation result of a luminance difference in the pixel is smaller than a reference value.

In the display system according to the another aspect of the invention described above, it is preferable that the luminance difference is calculated from the luminance value of the pixel and luminance values of a plurality of pixels adjacent to the pixel.

A display program according to still another aspect of the invention is a display program adapted to display an image, and making a computer function as a system including a first image data generation section adapted to perform a first image data generation process of generating first image data from data of the image, a second image data generation section adapted to generate second image data obtained by performing area coverage modulation on the first image data, and a display processing section adapted to perform a process of making an electronic paper display the image based on the second image data, wherein assuming that an outer edge pixel is a pixel in an outer edge of a figure included in the data of the image, and an outer peripheral pixel is a pixel located outside the figure and adjacent to the outer edge pixel, the first image data includes the outer edge pixel having a luminance value set to a value by a predetermined value larger than the data of the image, and the larger the color difference between the outer edge pixel and the outer peripheral pixel in the data of the image is, or the larger the saturation of the outer edge pixel in the display image data is, the larger the predetermined value is.

In the display program according to the still another aspect of the invention described above, it is preferable that the first image data generation section performs the first image data generation process if a luminance difference calculated in the outer edge pixel in the data of the image is smaller than a reference value.

A display program according to yet another aspect of the invention is a display program adapted to display an image, and making a computer function as a system including a first image data generation section adapted to perform a first image data generation process of generating first image data from data of the image, a second image data generation section adapted to generate second image data obtained by performing area coverage modulation on the first image data, and a display processing section adapted to perform a process of making an electronic paper display the image based on the second image data, wherein the first image data generation process is a process of increasing a luminance value in a pixel of the data of the image as much as a predetermined value if a calculation result of a luminance difference in the pixel is smaller than a reference value.

In the display program according to the yet another aspect of the invention described above, it is preferable that the luminance difference is calculated from the luminance value of the pixel and luminance values of a plurality of pixels adjacent to the pixel.

A display method according to still yet another aspect of the invention is a display method adapted to display an image including performing a first image data generation process of generating first image data from data of the image, generating second image data obtained by performing area coverage modulation on the first image data, and performing a process of making an electronic paper display the image based on the second image data, wherein assuming that an outer edge pixel is a pixel in an outer edge of a figure included in the data of the image, and an outer peripheral pixel is a pixel located outside the figure and adjacent to the outer edge pixel, the first image data includes the outer edge pixel having a luminance value set to a value by a predetermined value larger than the data of the image, and the larger the color difference between the outer edge pixel and the outer peripheral pixel in the data of the image is, or the larger the saturation of the outer edge pixel in the display image data is, the larger the predetermined value is.

In the display method according to the still yet another aspect of the invention described above, it is preferable that in the performing of the first image data generation process, the first image data generation process is performed if a luminance difference calculated in the data of the image is smaller than a reference value.

A display method according to further another aspect of the invention is a display method adapted to display an image including performing a first image data generation process of generating first image data from data of the image, generating second image data obtained by performing area coverage modulation on the first image data, and performing a process of making an electronic paper display the image based on the second image data, wherein in the performing of the first image data generation process, a process of increasing a luminance value in a pixel of the data of the image as much as a predetermined value if a calculation result of a luminance difference in the pixel is smaller than a reference value is performed.

In the display method according to the further another aspect of the invention described above, it is preferable that the luminance difference is calculated from the luminance value of the pixel and luminance values of a plurality of pixels adjacent to the pixel.

### APPLICATION EXAMPLE 1

A display system according to this application example is a display system adapted to perform display of display image data including a first image data generation section adapted to perform a first image data generation process of generating first image data, a second image data generation section adapted to generate second image data obtained by performing area coverage modulation on the first image data, and a display processing section adapted to perform a process of making an electronic paper display the image based on the second image data, wherein assuming that an outer edge pixel is a pixel in an outer edge of a figure included in the display image data, and an outer peripheral pixel is a pixel located outside the figure and adjacent to the outer edge pixel, the first image data is data having the difference in luminance between the outer edge pixel and the outer peripheral pixel by a predetermined value larger than the difference in luminance between the outer edge pixel and the outer peripheral pixel in the display image data, and the larger the color difference between the outer edge pixel and the outer peripheral pixel in the display data is, or the larger the saturation of the outer edge pixel in the display image data is, the larger the predetermined value is.

According to this application example, the first image data is arranged to have the difference between the luminance of the outer edge pixel of the figure included in the display image data and the luminance of the outer peripheral pixel as the pixel adjacent to the outer edge pixel and located outside the figure by the predetermined value larger than that of the display image data, which is an original data to be displayed, and the electric paper is made to display the image based on the second image data which is obtained by performing the area coverage modulation on the first image data. Therefore, the image having the figure expressed in halftone with the contour emphasized can be displayed. Further, according to the present application example, the larger the color difference between the outer edge pixel and the outer peripheral pixel is, or the larger the saturation of the outer edge pixel in the display image data is, the larger the predetermined value is set, and therefore, it is possible to display the image having the figure with the contour emphasized in a state closer to the actual feeling for the viewer. Therefore, it is possible to realize the display system with which the characters expressed in halftone, for example, are easy to be visually recognized.

### APPLICATION EXAMPLE 2

In the display system according to the application example described above, it is preferable that the first image data generation section performs the first image data generation process if a difference in luminance between the outer edge pixel and the outer peripheral pixel in the display image data is smaller than a reference value.

In the case in which the difference in luminance between the outer edge pixel and the outer peripheral pixel in the display image data is small, it is difficult to clearly show the contour of the figure based on the difference in luminance. According to the present application example, even in such a case, it is possible to realize the display system capable of displaying the image having the figure with the contour emphasized in the state closer to the actual feeling for the viewer by performing the first image data generation process.

### APPLICATION EXAMPLE 3

A display program according to this application example is a display program adapted to perform display of display image data and making a computer function as a system including a first image data generation section adapted to perform a first image data generation process of generating first image data, a second image data generation section adapted to generate second image data obtained by performing area coverage modulation on the first image data, and a display processing section adapted to perform a process of making an electronic paper display the image based on the second image data, wherein assuming that an outer edge pixel is a pixel in an outer edge of a figure included in the display image data, and an outer peripheral pixel is a pixel located outside the figure and adjacent to the outer edge pixel, the first image data is data having the difference in luminance between the outer edge pixel and the outer peripheral pixel by a predetermined value larger than the difference in luminance between the outer edge pixel and the outer peripheral pixel in the display image data, and the larger the color difference between the outer edge pixel and the outer peripheral pixel in the display image data is, or the larger the saturation of the outer edge pixel in the display image data is, the larger the predetermined value is.

According to this application example, the first image data is arranged to have the difference between the luminance of the outer edge pixel of the figure included in the display image data and the luminance of the outer peripheral pixel as the pixel adjacent to the outer edge pixel and located outside the figure by the predetermined value larger than that of the display image data, which is an original data to be displayed, and the electric paper is made to display the image based on the second image data which is obtained by performing the area coverage modulation on the first image data. Therefore, the image having the figure expressed in halftone with the contour emphasized can be displayed. Further, according to the present application example, in the display image data, the larger the color difference between the outer edge pixel and the outer peripheral pixel is, or the larger the saturation of the outer edge pixel in the display image data is, the larger the predetermined value is set, and therefore, it is possible to display the image having the figure with the contour emphasized in a state closer to the actual feeling for the viewer. Therefore, it is possible to realize the display program with which the characters expressed in halftone, for example, are easy to be visually recognized.

### APPLICATION EXAMPLE 4

In the display program according to the application example described above, it is preferable that the first image data generation section performs the first image data generation process if a difference in luminance between the outer edge pixel and the outer peripheral pixel in the display image data is smaller than a reference value.

In the case in which the difference in luminance between the outer edge pixel and the outer peripheral pixel in the display image data is small, it is difficult to clearly show the contour of the figure based on the difference in luminance. According to the present application example, even in such a case, it is possible to realize the display program capable of displaying the image having the figure with the contour emphasized in the state closer to the actual feeling for the viewer by performing the first image data generation process.

### APPLICATION EXAMPLE 5

A display method according to this application example is a display method adapted to perform display of display image data including performing a first image data generation process of generating first image data, generating second image data obtained by performing area coverage modulation on the first image data, and performing a process of making an electronic paper display the image based on the second image data, wherein assuming that an outer edge pixel is a pixel in an outer edge of a figure included in the display image data, and an outer peripheral pixel is a pixel located outside the figure and adjacent to the outer edge pixel, the first image data is data having the difference in luminance between the outer edge pixel and the outer peripheral pixel by a predetermined value larger than the difference in luminance between the outer edge pixel and the outer peripheral pixel in the display image data, and the larger the color difference between the outer edge pixel and the outer peripheral pixel in the display data is, or the larger the saturation of the outer edge pixel in the display image data is, the larger the predetermined value is.

According to this application example, the first image data is arranged to have the difference between the luminance of the outer edge pixel of the figure included in the display image data and the luminance of the outer peripheral pixel as the pixel adjacent to the outer edge pixel and located outside the figure by the predetermined value larger than that of the display image data, which is an original data to be displayed, and the electric paper is made to display the image based on the second image data which is obtained by performing the area coverage modulation on the first image data. Therefore, the image having the figure expressed in halftone with the contour emphasized can be displayed. Further, according to the present application example, in the display image data, the larger the color difference between the outer edge pixel and the outer peripheral pixel is, or the larger the saturation of the outer edge pixel in the display image data is, the larger the predetermined value is set, and therefore, it is possible to display the image having the figure with the contour emphasized in a state closer to the actual feeling for the viewer. Therefore, it is possible to realize the display method with which the characters expressed in halftone, for example, are easy to be visually recognized.

### APPLICATION EXAMPLE 6

In the display method according to the application example described above, it is preferable that in the performing of the first image data generation process, the first image data generation process is performed if a difference in luminance between the outer edge pixel and the outer peripheral pixel in the display image data is smaller than a reference value.

In the case in which the difference in luminance between the outer edge pixel and the outer peripheral pixel in the display image data is small, it is difficult to clearly show the contour of the figure based on the difference in luminance. According to the present application example, even in such a case, it is possible to realize the display method capable of displaying the image having the figure with the contour emphasized in the state closer to the actual feeling for the viewer by performing the first image data generation process.

### BRIEF DESCRIPTION OF THE DRAWINGS

The invention will be described with reference to the accompanying drawings, wherein like numbers reference like elements.

FIG. 1 is a functional block diagram of a display system according to an embodiment of the invention.

FIG. 2 is a diagram showing a configuration example of the display system according to the embodiment.

FIG. 3 is a flowchart for explaining a display method according to the embodiment.

FIGS. 4A and 4B are diagrams for explaining a positional relationship between a figure, and outer edge pixels, inner pixels, and outer peripheral pixels included in display image data.

FIG. 5 is a diagram for explaining an arrangement of the pixels.

FIG. 6 is a diagram showing a first color image as an example of the display image data.

FIG. 7 is a diagram showing a second color image as an example of the display image data.

FIG. 8A is a diagram showing an image obtained by performing area coverage modulation based on first image data based on the first color image, and FIG. 8B is a diagram showing an image obtained by performing the area coverage modulation based on the display image data corresponding to the first color image.

FIG. 9A is a diagram showing an image obtained by performing the area coverage modulation based on the first image data based on the second color image, and FIG. 9B is a diagram showing an image obtained by performing the area coverage modulation based on the display image data corresponding to the second color image.

FIGS. 10A and 10B are graphs each showing a correspondence relationship between s0 and s0′.

### DESCRIPTION OF EXEMPLARY EMBODIMENTS

Hereinafter, some preferred embodiments of the invention will be described in detail with reference to the accompanying drawings. It should be noted that the embodiment described below does not unreasonably limit the contents of the invention as set forth in the appended claims. Further, all of the constituents described below are not necessarily essential elements of the invention. The drawings are only for the sake of convenience of explanation.

Hereinafter, the embodiments of the invention will be explained along the following order.
1. Overall Configuration of Display system, Display program, and Display method
1-1. First Embodiment
1-2. Second Embodiment
1-3. Third Embodiment
2. Specific Example of Process in First Image Data Generation Section
2-1. First Specific Example
2-2. Second Specific Example
2-3. Third Specific Example
2-4. Fourth Specific Example
2-5. Fifth Specific Example
2-6. Sixth Specific Example
2-7. Modified Examples

### 1. OVERALL CONFIGURATION OF DISPLAY SYSTEM, DISPLAY PROGRAM, AND DISPLAY METHOD

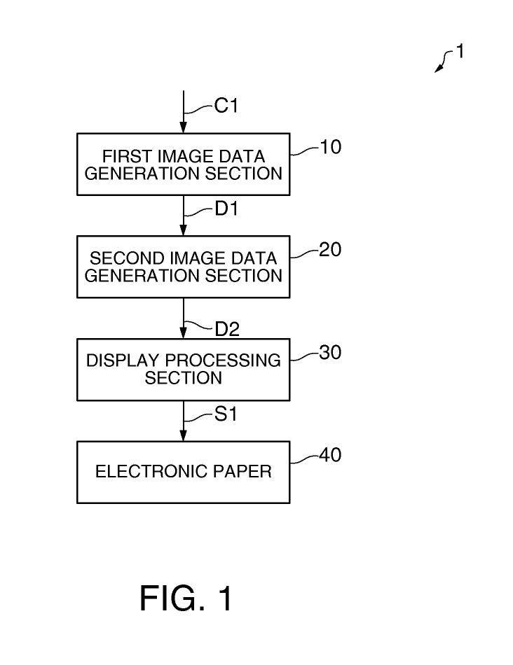

FIG. 1 is a functional block diagram of a display system 1 according to an embodiment of the invention. Hereinafter, the explanation of the display system, the display program, and the display method will be explained in a first embodiment, a second embodiment, and a third embodiment, respectively, as an overall configuration. It should be noted that in either of the embodiments, the same functions and the same constituents are denoted with substantially the same names and reference numerals, and the explanation for the functions and the constituents having already been explained may be omitted in some cases.

### 1-1. FIRST EMBODIMENT

The display system 1 according to the present embodiment is a system for performing the display of display image data C1, and has a first image data generation section 10, a second image data generation section 20, and a display processing section 30.

The first image data generation section 10 performs a first image data generation process for generating first image data D1. Assuming that outer edge pixels are the pixels in the outer edge of a figure included in the display image data C1, and outer peripheral pixels are the pixels located outside the figure and adjacent to the outer edge pixels, the first image data D1 is the data arranged to have the difference in luminance between the outer edge pixels and the outer peripheral pixels by a predetermined value E1 larger than the difference in luminance between the outer edge pixels and the outer peripheral pixels in the display image data C1.

Further, the larger the color difference between the outer edge pixels and the outer peripheral pixels in the display image data C1 is, or the higher the saturation of the outer edge pixels in the display image data C1 is, the larger the predetermined value E1 is.

Further, it is possible for the first image data generation section 10 to perform the first image data generation process in the case in which the difference in luminance between the outer edge pixels and the outer peripheral pixels in the display image data C1 is smaller than a reference value.

It should be noted that the details of the process performed by the first image data generation section 10 will be described later in the paragraph of “2. Specific Example of Process in First Image Data Generation Section.”

A second image data generation section 20 generates second image data D2 obtained by performing the area coverage modulation on the first image data D1 generated by the first image data generation section 10. It is possible for the second image data generation section 20 to generate the second image data D2 by performing the area coverage modulation on the first image data D1 using a variety of known methods such as a dither method or a density pattern method.

The display processing section 30 performs a process of making an electronic paper 40 display an image based on the second image data D2 generated by the second image data generation section 20. In the example shown in FIG. 1, the display processing section 30 outputs a control signal S1 to the electronic paper 40 to thereby perform the process of making the electronic paper 40 display the image.

The electronic paper 40 can be a variety of known electronic papers such as an electrophoretic type, a microcapsule type, a quick-response liquid powder type, a liquid crystal type, an electro-wetting type, or a chemical reaction type.

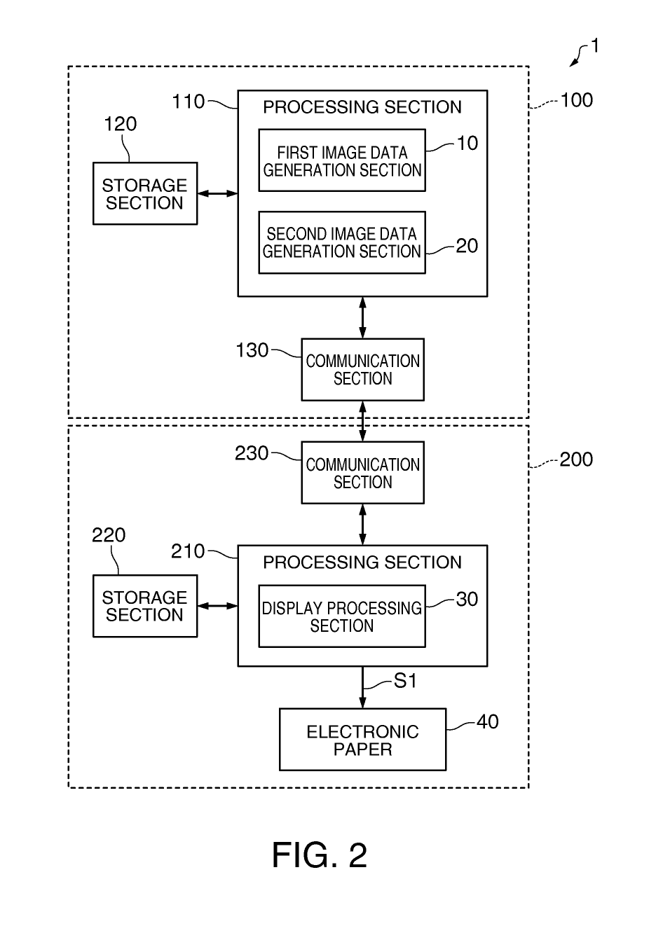

FIG. 2 is a diagram showing a configuration example of the display system 1 according to the present embodiment. The display system 1 shown in FIG. 2 is configured including a personal computer 100 and a display device 200.

The personal computer 100 is configured including a processing section 110, a storage section 120, and a communication section 130. The display device 200 is configured including a processing section 210, a storage section 220, a communication section 230, and the electronic paper 40.

In the example shown in FIG. 2, the first image data generation section 10 and the second image data generation section 20 are configured as a part of the processing section 110. The processing section 110 can also be formed of, for example, a central processing unit (CPU).

The storage section 120 can function as a temporary working memory for the process performed by the processing section 110, or can also function as a storage section for storing the display image data C1. It should be noted that the display image data C1 can also be input from the outside of the personal computer 100.

The communication section 130 has a function of providing an interface for communicating with the outside of the personal computer 100 via a communication line.

In the example shown in FIG. 2, the display processing section 30 is configured as a part of the processing section 210. The processing section 210 can also be formed of, for example, a CPU. The processing section 210 outputs the control signal S1 to thereby control the electronic paper 40.

The storage section 220 can also function as a temporary working memory for the process performed by the processing section 210.

The communication section 230 has a function of providing an interface for communicating with the outside of the display device 200 via a communication line.

In the example shown in FIG. 2, the communication section 130 of the personal computer 100 and the communication section 230 of the display device 200 are connected to each other via a predetermined communication method. Here, the predetermined communication method is not required to be particularly limited providing the necessary data transfer rate is assured. For example, the communication method can also be the universal serial bus (USB).

In the example shown in FIG. 2, the first image data generation section 10 and the second image data generation section 20 are configured as a part of the personal computer 100. Further, in the embodiment of the invention the display processing section 30 is configured as a part of the display device 200 including the electronic paper 40. However, the invention is not limited thereto, but for example, all of the first image data generation section 10, the second image data generation section 20, and the display processing section 30 can also be configured as a part of the display device 200.

It should be noted that the first image data generation section 10, the second image data generation section 20, and the display processing section 30 can also be realized using a dedicated electronic circuit, or can be realized using a program executable by the CPU.

According to the display system 1 related to the present embodiment, the first image data D1 is arranged to have the difference between the luminance of the outer edge pixels of a figure included in the display image data and the luminance of the outer peripheral pixels as the pixels adjacent to the outer edge pixels and located outside the figure by the predetermined value E1 larger than that of the display image data C1, which is an original data to be displayed, and the electric paper 40 is made to display the image based on the second image data D2 which is obtained by performing the area coverage modulation on the first image data D1. Therefore, the image having the figure expressed in halftone with the contour emphasized can be displayed. Further, according to the display system 1 related to the present embodiment, the larger the color difference between the outer edge pixels and the outer peripheral pixels in the display image data is, or the larger the saturation of the outer edge pixels in the display image data is, the larger the predetermined value is set, and therefore, it is possible to display the image having the figure with the contour emphasized in a state closer to the actual feeling for the viewer. Therefore, it is possible to realize the display system with which the characters expressed in halftone, for example, are easy to be visually recognized.

In the case in which the difference in luminance between the outer edge pixels and the outer peripheral pixels in the display image data C1 is small, it is difficult to clearly show the contour of the figure based on the difference in luminance. According to the display system 1 related to the present embodiment, even in such a case, it is possible to realize the display system 1 capable of displaying the image having the figure with the contour emphasized in the state closer to the actual feeling for the viewer by performing the first image data generation process.

### 1-2. SECOND EMBODIMENT

The first image data generation section 10, the second image data generation section 20, and the display processing section 30 can also be realized as a program executed by, for example, a computer. Specifically, the display program according to the present embodiment is a display program for performing the display of the display image data C1, and is a display program for making the computer function as the first image data generation section 10 for performing the first image data generation process for generating the first image data D1, the second image data generation section 20 for generating the second image data D2 obtained by performing the area coverage modulation on the first image data D1, and the display processing section 30 for performing the process of making the electronic paper 40 display the image based on the second image data D2. Similarly to the first embodiment, assuming that outer edge pixels are the pixels in the outer edge of a figure included in the display image data, and outer peripheral pixels are the pixels located outside the figure and adjacent to the outer edge pixels, the first image data D1 is the data arranged to have the difference in luminance between the outer edge pixels and the outer peripheral pixels by a predetermined value E1 larger than the difference in luminance between the outer edge pixels and the outer peripheral pixels in the display image data C1, and the larger the color difference between the outer peripheral pixels and the outer edge pixels in the display image data C1 is, or the higher the saturation of the outer edge pixels in the display image data C1 is, the larger the predetermined value E1 is.

Also in this case, it is possible for the first image data generation section 10 to perform the first image data generation process in the case in which the difference in luminance between the outer edge pixels and the outer peripheral pixels in the display image data C1 is smaller than the reference value.

According to the display program related to the present embodiment, the first image data D1 is arranged to have the difference between the luminance of the outer edge pixels of a figure included in the display image data and the luminance of the outer peripheral pixels as the pixels adjacent to the outer edge pixels and located outside the figure by the predetermined value E1 larger than that of the display image data C1, which is an original data to be displayed, and the electronic paper 40 is made to display the image based on the second image data D2 which is obtained by performing the area coverage modulation on the first image data D1. Therefore, the image having the figure expressed in halftone with the contour emphasized can be displayed. Further, according to the display program related to the present embodiment, the larger the color difference between the outer edge pixels and the outer peripheral pixels in the display image data is, or the larger the saturation of the outer edge pixels in the display image data is, the larger the predetermined value is set, and therefore, it is possible to display the image having the figure with the contour emphasized in a state closer to the actual feeling for the viewer. Therefore, it is possible to realize the display program with which the characters expressed in halftone, for example, are easy to be visually recognized.

In the case in which the difference in luminance between the outer edge pixels and the outer peripheral pixels in the display image data C1 is small, it is difficult to clearly show the contour of the figure based on the difference in luminance. According to the display system 1 related to the present embodiment, even in such a case, it is possible to realize the function as a program, which is capable of displaying the image having the figure with the contour emphasized in the state closer to the actual feeling for the viewer by performing the first image data generation process.

### 1-3. THIRD EMBODIMENT

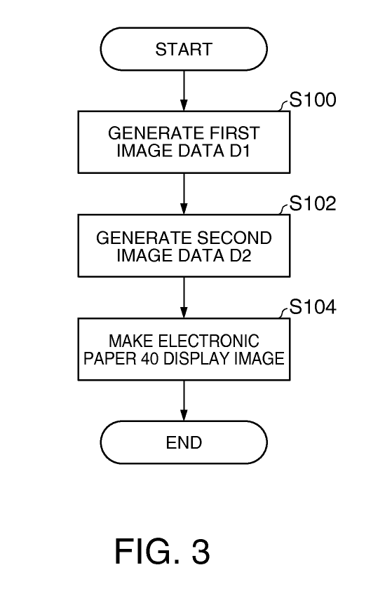

FIG. 3 is a flowchart for explaining a display method according to the present embodiment. Hereinafter, an example of realizing the display method according to the present embodiment using the display system 1 shown in FIG. 1 will be explained.

The display method according to the present embodiment is a display method for performing the display of the display image data C1, and has a first image data generation process (step S100) for performing the first image data generation process for generating the first image data D1, a second image data generation process (step S102) for generating the second image data D2 obtained by performing the area coverage modulation on the first image data D1, and a display processing process (step S104) for performing the process of making the electronic paper 40 display the image based on the second image data D2.

In FIG. 3, firstly the first image data generation process for generating the first image data D1 is performed (step S100). In the present embodiment, the first image data generation section 10 performs the first image data generation process. Assuming that outer edge pixels are the pixels in the outer edge of a figure included in the display image data C1, and outer peripheral pixels are the pixels located outside the figure and adjacent to the outer edge pixels, the first image data D1 is the data arranged to have the difference in luminance between the outer edge pixels and the outer peripheral pixels by a predetermined value E1 larger than the difference in luminance between the outer edge pixels and the outer peripheral pixels in the display image data C1, and the larger the color difference between the outer edge pixels and the outer peripheral pixels in the display image data C1 is, or the higher the saturation of the outer edge pixels in the display image data is, the larger the predetermined value E1 is.

In the first image data generation process, it is also possible to perform the first image data generation process in the case in which the difference in luminance between the outer edge pixels and the outer peripheral pixels is smaller than the reference value.

After the step S100, the second image data generation process for generating the second image data D2 obtained by performing the area coverage modulation on the first image data D1 is performed (step S102). In the present embodiment, the second image data generation section 20 performs the second image data generation process.

After the step S102, the display processing process for performing the process of making the electronic paper 40 display the image based on the second image data D2 is performed (step S104). In the present embodiment, the display processing section 30 performs the display processing process.

According to the display method related to the present embodiment, the first image data D1 is arranged to have the difference between the luminance of the outer edge pixels of a figure included in the display image data C1 and the luminance of the outer peripheral pixels as the pixels adjacent to the outer edge pixels and located outside the figure by the predetermined value E1 larger than that of the display image data C1, which is an original data to be displayed, and the electric paper is made to display the image based on the second image data D2 which is obtained by performing the area coverage modulation on the first image data D1. Therefore, the image having the figure expressed in halftone with the contour emphasized can be displayed. Further, according to the display method related to the present embodiment, the larger the color difference between the outer edge pixels and the outer peripheral pixels in the display image data C1 is, or the larger the saturation of the outer edge pixels in the display image data is, the larger the predetermined value E1 is set, and therefore, it is possible to display the image having the figure with the contour emphasized in a state closer to the actual feeling for the viewer. Therefore, it is possible to realize the display method with which the characters expressed in halftone, for example, are easy to be visually recognized.

In the case in which the difference in luminance between the outer edge pixels and the outer peripheral pixels in the display image data C1 is small, it is difficult to clearly show the contour of the figure based on the difference in luminance. According to the display method related to the present embodiment, even in such a case, it is possible to realize the display method capable of displaying the image having the figure with the contour emphasized in the state closer to the actual feeling for the viewer by performing the first image data generation process.

### 2. SPECIFIC EXAMPLE OF PROCESS IN FIRST IMAGE DATA GENERATION SECTION

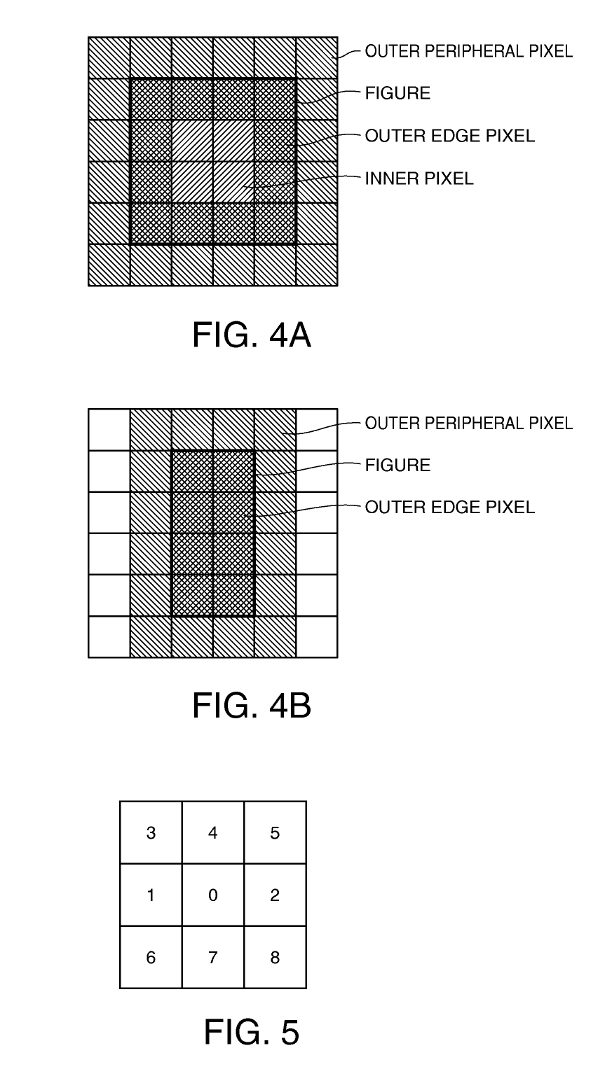

Then, a specific example of the process in the first image data generation section 10 will be explained. FIGS. 4A and 4B are diagrams for explaining a positional relationship between the figure, and the outer edge pixels, the inner pixels, and the outer peripheral pixels included in the display image data C1.

FIG. 4A shows an example in which the figure is composed of the outer edge pixels and the inner pixels. FIG. 4B shows an example in which the figure is composed only of the outer edge pixels. Each of the pixels corresponds to one pixel in the display image data C1.

In FIGS. 4A and 4B, the figure is a region surrounded by the thick solid lines. In FIGS. 4A and 4B, the outer edge pixels are the pixels shaded with mesh. In FIGS. 4A and 4B, the inner pixels are the pixels shaded with oblique lines drawn from upper right to lower left. In FIGS. 4A and 4B, the outer peripheral pixels are the pixels shaded with oblique lines drawn from upper left to lower right.

As shown in FIGS. 4A and 4B, the outer edge pixels are the pixels located inside the figure and having contact with the outer edge of the figure. Further, the inner pixels are the pixels located inside the figure without having contact with the outer edge of the figure. Further, the outer peripheral pixels are the pixels located outside the figure and adjacent to the outer edge pixels.

FIG. 5 is a diagram for explaining an arrangement of the pixels. In FIG. 5, a zeroth pixel to be the processing object in the process by the first image data generation section 10 is indicated as “0.” Similarly, a first pixel, which is a pixel located on the immediate left of the zeroth pixel, is indicated as “1,” a second pixel, which is a pixel located on the immediate right of the zeroth pixel is indicated as “2,” a third pixel, which is a pixel located on the immediate upper left of the zeroth pixel is indicated as “3,” a fourth pixel, which is a pixel located on the immediate upper side of the zeroth pixel is indicated as “4,” a fifth pixel, which is a pixel located on the immediate upper right of the zeroth pixel is indicated as “5,” a sixth pixel, which is a pixel located on the immediate lower left of the zeroth pixel is indicated as “6,” a seventh pixel, which is a pixel located on the immediate lower side of the zeroth pixel is indicated as “7,” and an eighth pixel, which is a pixel located on the immediate lower right of the zeroth pixel is indicated as “8.”

In the explanation of the specific example described below, it is assumed that the luminance of the zeroth pixel is y0, the luminance of the first pixel is y1, the luminance of the second pixel is y2, the luminance of the third pixel is y3, the luminance of the fourth pixel is y4, the luminance of the fifth pixel is y5, the luminance of the sixth pixel is y6, the luminance of the seventh pixel is y7, and the luminance of the eighth pixel is y8. In the specific example described below, the luminance is a value in a range of 0 through 255.

In the explanation of the specific example described below, assuming that the outer edge pixel is the zeroth pixel, the difference in luminance (luminance difference) Ysa between the outer edge pixel and the adjacent pixel is defined by the formula 1 below.

Ysa={4×y0−(y4+y1+y2+y7)}×0.5 (1)

In the specific example described below, it is assumed that the first image data generation section 10 performs the first image data generation process if the absolute value of the luminance difference Ysa is smaller than 50, namely if −50<Ysa<50 is fulfilled. In other words, the reference value is 50.

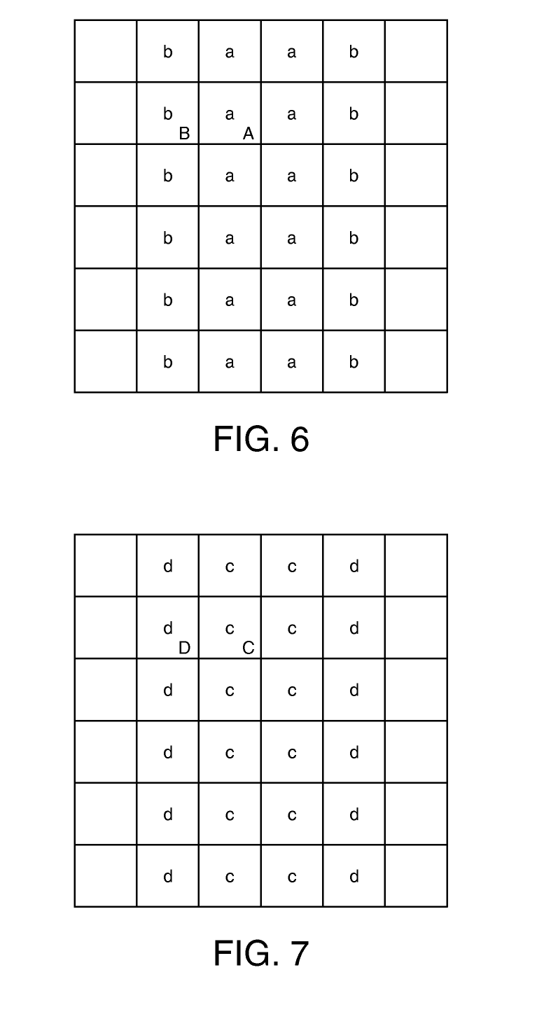

FIG. 6 is a diagram showing a first color image as an example of the display image data C1. FIG. 7 is a diagram showing a second color image as an example of the display image data C1. The inside area of each of the grid like frames shown in FIGS. 6 and 7 corresponds to the pixel.

It is assumed that the plurality of pixels “a” shown in FIG. 6 corresponds to the outer edge pixels, and the plurality of pixels “b” corresponds to the outer peripheral pixels. The pixels “a” have a color represented by (R, G, B)=(255, 60, 255) in an RGB color system of an 8-bit representation. The luminance in an 8-bit representation of the pixels “a” is 141. The pixels “b” have a color represented by (R, G, B)=(18, 227, 227) in the RGB color system of the 8-bit representation. The luminance in the 8-bit representation of the pixels “b” is 164. Therefore, the difference between the luminance of the outer edge pixels and the luminance of the outer peripheral pixels is 23. It should be noted that the plain pixels have a color (the same color as that of the pixels “b”) represented by (R, G, B)=(18, 227, 227) in the RGB color system of the 8-bit representation.

It is assumed that the plurality of pixels “c” shown in FIG. 7 corresponds to the outer edge pixels, and the plurality of pixels “d” corresponds to the outer peripheral pixels. The pixels “c” have a color represented by (R, G, B)=(255, 162, 255) in the RGB color system of the 8-bit representation. The luminance in the 8-bit representation of the pixels “c” is 201. The pixels “d” have a color represented by (R, G, B)=(190, 240, 240) in the RGB color system of the 8-bit representation. The luminance in the 8-bit representation of the pixels “d” is 225. Therefore, the difference between the luminance of the outer edge pixels and the luminance of the outer peripheral pixels is 24. It should be noted that the plain pixels have a color (the same color as that of the pixels “d”) represented by (R, G, B)=(190, 240, 240) in the RGB color system of the 8-bit representation.

In the case of assuming that the pixel A shown in FIG. 6 is the zeroth pixel, the luminance difference Ysa is 12. In the case of assuming that the pixel C shown in FIG. 7 is the zeroth pixel, the luminance difference Ysa is 12. Therefore, the luminance difference Ysa is equal to or smaller than the reference value in either of the cases, and in the following specific examples, the first image data generation section 10 performs the first image data generation process on both of the first color image and the second color image.

Here, it is assumed that the luminance ynew of the zeroth pixel after the first image data generation process in the first image data generation section 10 is expressed by the formula 2 below.

ynew=y0+Δy (2)

### 2-1. FIRST SPECIFIC EXAMPLE

In the first specific example, an example of the case of performing the first image data generation process in an HSV system will be explained. Hereinafter, it is assumed that the hue (H) takes a value in a range of 0 through 359, and the saturation (S) takes a value in a range of 0 through 255.

In the explanation described below, it is assumed that the hue (H) of the zeroth pixel is h0, the hue (H) of the first pixel is h1, the hue (H) of the second pixel is h2, the hue (H) of the third pixel is h3, the hue (H) of the fourth pixel is h4, the hue (H) of the fifth pixel is h5, the hue (H) of the sixth pixel is h6, the hue (H) of the seventh pixel is h7, and the hue (H) of the eighth pixel is h8. Similarly, it is assumed that the saturation (S) of the zeroth pixel is s0, the saturation (S) of the first pixel is s1, the saturation (S) of the second pixel is s2, the saturation (S) of the third pixel is s3, the saturation (S) of the fourth pixel is s4, the saturation (S) of the fifth pixel is s5, the saturation (S) of the sixth pixel is s6, the saturation (S) of the seventh pixel is s7, and the saturation (S) of the eighth pixel is s8.

The color difference in the first specific example is defined by the formula 3 below.

Sa′=Ssa/2+Hsa/4 (3)

In the formula 3, Ssa is defined by the formula 4 below.

Ssa=|{4×s0−(s4+s1+s2+s7)}| (4)

In the formula 3, Hsa is defined by the formula 5 below.

Hsa=Hs1+Hs2+Hs3+Hs4 (5)

In the formula 5, Hs1, Hs2, Hs3, and Hs4 are defined respectively by the formula 6, the formula 7, the formula 8, and the formula 9 described below.

Hs1=|h0−h1| (6)

Hs2=|h0−h2| (7)

Hs3=↑h0−h4| (8)

Hs4=|h0−h7| (9)

In the formulas 6 through 9 described above, “||” represents an absolute value (the same applies hereinafter). Further, in the formulas 6 through 9 described above, Hs1, Hs2, Hs3, and Hs4 are calculated so as to have a value equal to or lower than 180. More specifically, they are calculated so as to have a value equal to or lower than 180 by subtracting 180 if the value exceeds 180.

On this occasion, Δy is obtained using the formula 10 or the formula 11 described below.

Δy=Ysa+Sa (if Ysa≧0 is true) (10)

Δy=Ysa−Sa (if Ysa<0 is true) (11)

In the formula 10 and the formula 11 described above, Sa is obtained using the formula 12 below.

Sa=Sa′×s0/128 (12)

It should be noted that it is possible to limit the maximum value and the minimum value of Δy. In the present specific example, it is assumed that Δy takes a value in a range of −80 through 50.

In the pixels “a” of the first color image shown in FIG. 6, H=300 and S=195 in the HSV system are set. In the pixels “b” of the first color image shown in FIG. 6, H=180 and S=234 in the HSV system are set.

In this case, in the case of assuming that the pixel A is the zeroth pixel, since Δy=−87 is obtained, the minimum value of Δy=−80 is used, and by substituting the value in the formula 2, ynew=61 is obtained.

Similarly, in the case of assuming that the pixel B is the zeroth pixel, since Δy=103 is obtained, the maximum value of Δy=50 is used, and by substituting the value in the formula 2, ynew=214 is obtained.

Therefore, after performing the first image data generation process, the difference between the luminance of the outer edge pixels and the luminance of the outer peripheral pixels is 153. In other words, the difference is increased as much as the predetermined value E1=130.

In the pixels “c” of the second color image shown in FIG. 7, H=300 and S=93 in the HSV system are set. In the pixels “d” of the second color image shown in FIG. 7, H=180 and S=53 in the HSV system are set.

In this case, in the case of assuming that the pixel C is the zeroth pixel, Δy=−48 is obtained, and by substituting the value in the formula 2, ynew=153 is obtained.

Similarly, in the case of assuming that the pixel D is the zeroth pixel, Δy=33 is obtained, and by substituting the value in the formula 2, ynew=258 is obtained, and therefore, the maximum value of ynew=255 is set.

Therefore, after performing the first image data generation process, the difference between the luminance of the outer edge pixels and the luminance of the outer peripheral pixels is 102. In other words, the difference is increased as much as the predetermined value E1=78.

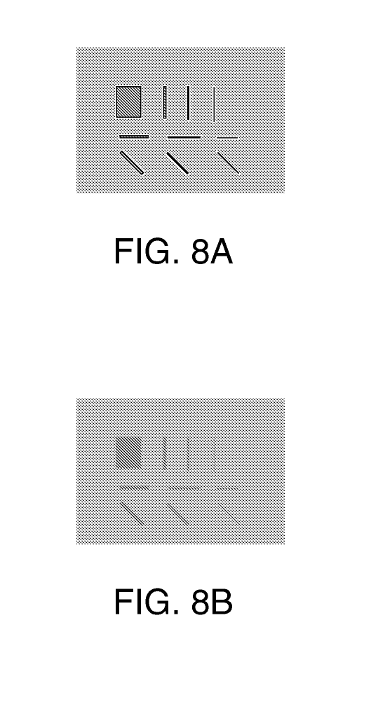

FIG. 8A is a diagram showing an image obtained by performing the area coverage modulation based on the first image data D1 based on the first color image, and FIG. 8B is a diagram showing an image obtained by performing the area coverage modulation based on the display image data C1 corresponding to the first color image. By comparing the diagram shown in FIG. 8A and the diagram shown in FIG. 8B with each other, it is understood that the figure in the diagram shown in FIG. 8A has the contour emphasized more strongly, and is easier to be visually recognized.

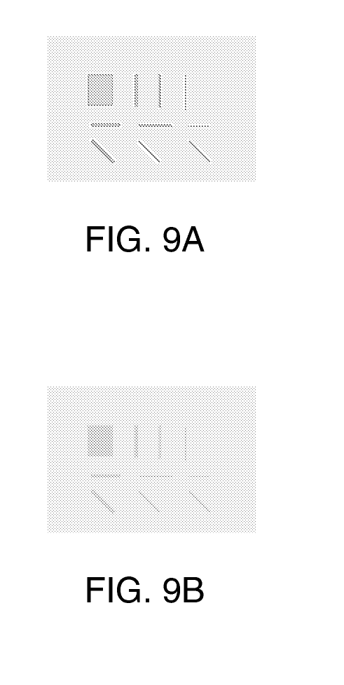

FIG. 9A is a diagram showing an image obtained by performing the area coverage modulation based on the first image data D1 based on the second color image, and FIG. 9B is a diagram showing an image obtained by performing the area coverage modulation based on the display image data C1 corresponding to the second color image. By comparing the diagram shown in FIG. 9A and the diagram shown in FIG. 9B with each other, it is understood that the figure in the diagram shown in FIG. 9A has the contour emphasized more strongly, and is easier to be visually recognized.

By comparing FIG. 8A and FIG. 9A with each other, it is understood that the figure in the diagram shown in FIG. 8A has the contour emphasized more strongly than the other. Therefore, it is understood that the contour of the figure is emphasized in a state closer to the actual feeling for the viewer.

As described above, according to the first specific example, it is possible to display the image with, for example, the figure expressed in halftone having the contour emphasized. Further, it is possible to display the image having the figure with the contour emphasized in a state closer to the actual feeling for the viewer. Therefore, it is possible to realize the display system 1, the display program, and the display method with which the characters expressed in halftone, for example, are easy to be visually recognized.

### 2-2. SECOND SPECIFIC EXAMPLE

In the first specific example, it is possible to obtain Sa using the formula 13 below instead of the formula 12.

Sa=Sa′/4+s0/16 (13)

Also in the second specific example, substantially the same advantages as in the first specific example can be obtained.

### 2-3. THIRD SPECIFIC EXAMPLE

In the third specific example, an example of the case of performing the first image data generation process in a YUV system will be explained. Hereinafter, it is assumed that the luminance (Y) takes a value in a range of 0 through 255, and the u-color difference (U) and the v-color difference (V) each take a value in a range of −128 through 127.

In the explanation described below, it is assumed that the u-color difference (U) of the zeroth pixel is u0, the u-color difference (U) of the first pixel is u1, the u-color difference (U) of the second pixel is u2, the u-color difference (U) of the third pixel is u3, the u-color difference (U) of the fourth pixel is u4, the u-color difference (U) of the fifth pixel is u5, the u-color difference (U) of the sixth pixel is u6, the u-color difference (U) of the seventh pixel is u7, and the u-color difference (U) of the eighth pixel is u8. In the explanation described below, it is assumed that the v-color difference (V) of the zeroth pixel is v0, the v-color difference (V) of the first pixel is v1, the v-color difference (V) of the second pixel is v2, the v-color difference (V) of the third pixel is v3, the v-color difference (V) of the fourth pixel is v4, the v-color difference (V) of the fifth pixel is v5, the v-color difference (V) of the sixth pixel is v6, the v-color difference (V) of the seventh pixel is v7, and the v-color difference (V) of the eighth pixel is v8.

The color difference in the third specific example is defined by the formula 14 below.

Sa′=Usa+Vsa (14)

In the formula 14, Usa is defined by the formula 15 below.

Usa=|{4×u0−(u4+u1+u2+u7)}| (15)

In the formula 14, Vsa is defined by the formula 16 below.

Vsa=|{4×v0−(v4+v1+v2+v7)}| (16)

On this occasion, Δy is obtained using the formula 10 or the formula 11 described above. In the formula 10 and the formula 11 described above, Sa is obtained using the formula 17 below.

Sa=Sa′×(|u0|+|v0|)/512 (17)

It should be noted that similarly to the first specific example, it is possible to limit the maximum value and the minimum value of Δy.

Also in the third specific example of performing the first image data generation process in the YUV system, substantially the same advantages as in the first specific example of performing the first image data generation process in the HSV system can be obtained.

### 2-4. FOURTH SPECIFIC EXAMPLE

In the third specific example, it is possible to obtain Sa using the formula 18 below instead of the formula 17.

Sa=Sa′/16+(|u0|+|v0|)/32 (18)

Also in the fourth specific example, substantially the same advantages as in the third specific example can be obtained.

### 2-5. FIFTH SPECIFIC EXAMPLE

In the fifth specific example, an example of the case of performing the first image data generation process in an RGB system will be explained. Hereinafter, it is assumed that a red component (R), a green component (G), and a blue component (B) each take a value in a range of 0 through 255.

In the explanation described below, it is assumed that the red component (R) of the zeroth pixel is r0, the red component (R) of the first pixel is r1, the red component (R) of the second pixel is r2, the red component (R) of the third pixel is r3, the red component (R) of the fourth pixel is r4, the red component (R) of the fifth pixel is r5, the red component (R) of the sixth pixel is r6, the red component (R) of the seventh pixel is r7, and the red component (R) of the eighth pixel is r8. Similarly, it is assumed that the green component (G) of the zeroth pixel is g0, the green component (G) of the first pixel is g1, the green component (G) of the second pixel is g2, the green component (G) of the third pixel is g3, the green component (G) of the fourth pixel is g4, the green component (G) of the fifth pixel is g5, the green component (G) of the sixth pixel is g6, the green component (G) of the seventh pixel is g7, and the green component (G) of the eighth pixel is g8. Further, it is assumed that the blue component (B) of the zeroth pixel is b0, the blue component (B) of the first pixel is b1, the blue component (B) of the second pixel is b2, the blue component (B) of the third pixel is b3, the blue component (B) of the fourth pixel is b4, the blue component (B) of the fifth pixel is b5, the blue component (B) of the sixth pixel is b6, the blue component (B) of the seventh pixel is b7, and the blue component (B) of the eighth pixel is b8.

The color difference in the fifth specific example is defined by the formula 19 below.

Sa'=Rsa+Gsa+Bsa (19)

In the formula 19, Rsa is defined by the formula 20 below.

Rsa=|{4×r0−(r4+r1+r2+r7)}| (20)

In the formula 19, Gsa is defined by the formula 21 below.

Gsa=|{4×g0−(g4+g1+g2+g7)}| (21)

In the formula 19, Bsa is defined by the formula 22 below.

Bsa=|{4×b0−(b4+b1+b2+b7)}| (22)

On this occasion, Δy is obtained using the formula 10 or the formula 11 described above. In the formula 10 and the formula 11 described above, Sa is obtained using the formula 23 below.

Sa=Sa′×rgb/512 (23)

In the formula 23, rgb is defined by the formula 24 below.

rgb=|r0−g0|+|b0−g0|+|r0−b0| (24)

It should be noted that similarly to the first specific example, it is possible to limit the maximum value and the minimum value of Δy.

Also in the fifth specific example of performing the first image data generation process in the RGB system, substantially the same advantages as in the first specific example of performing the first image data generation process in the HSV system can be obtained.

### 2-6. SIXTH SPECIFIC EXAMPLE

In the fifth specific example, it is possible to obtain Sa using the formula 25 below instead of the formula 23.

Sa=Sa′/16+rgb/32 (25)

Also in the sixth specific example, substantially the same advantages as in the fifth specific example can be obtained.

### 2-7. MODIFIED EXAMPLES

In the first and second specific examples, it is possible to use the formula 12′ and the formula 13′ described below instead of the formula 12 and the formula 13, respectively.

Sa=Sa′×s0/128 (12′)

Sa=Sa′/4+s0′/16 (13′)

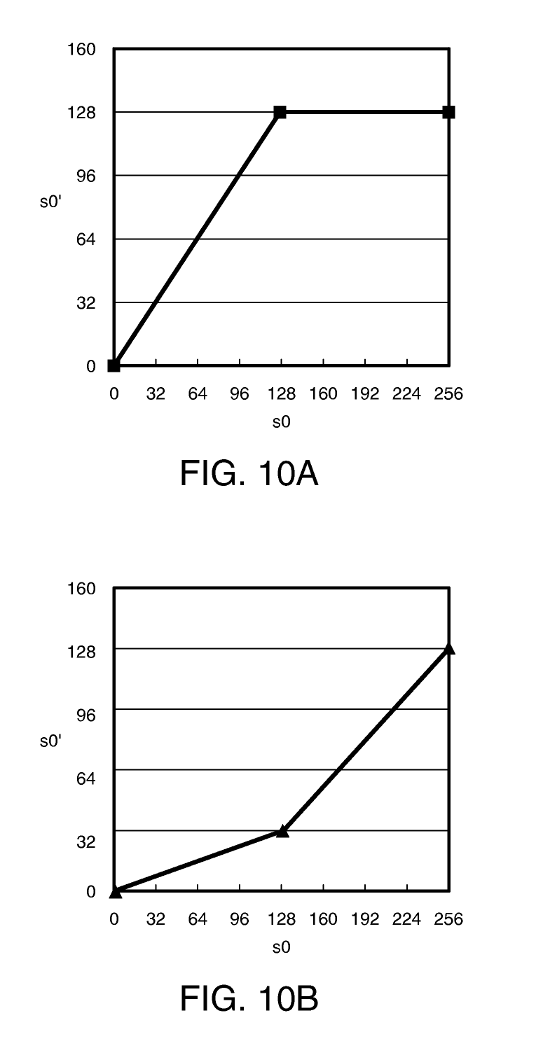

FIGS. 10A and 10B are graphs each showing a correspondence relationship between s0 and s0′. As shown in FIGS. 10A and 10B, there can be adopted the relationship between s0′ and s0 in which s0′ increases monotonically with respect to s0, and is not directly proportional to s0.

The invention is not limited to the specific examples described above, but it is possible to perform the first image data generation process in, for example, the La*b* color space or the Lu*v* color space.

It should be noted that the embodiments and the modified examples described above are illustrative only, and the invention is not at all limited thereto. For example, it is possible to arbitrarily combine the embodiments and the modified examples described above with each other.

The invention is not limited to the embodiments and the specific examples described above, but can further be modified variously. For example, the invention includes configurations (e.g., configurations having the same function, the same way, and the same result, or configurations having the same object and the same advantage) substantially the same as those described as the embodiments. Further, the invention includes configurations obtained by replacing a non-essential part of the configurations described in the embodiment section. Further, the invention includes configurations providing the same functions and the same advantages or configurations capable of achieving the same object as the configurations described as the embodiments. Further, the invention includes configurations obtained by adding technologies known to the public to the configurations described as the embodiments.

What is claimed is:

1. A display system adapted to display an image, comprising:
a first image data generation section adapted to perform a first image data generation process of generating first image data from data of the image;
a second image data generation section adapted to generate second image data obtained by performing area coverage modulation on the first image data; and
a display processing section adapted to perform a process of making an electronic paper display the image based on the second image data,
wherein assuming that an outer edge pixel is a pixel in an outer edge of a figure included in the data of the image, and an outer peripheral pixel is a pixel located outside the figure and adjacent to the outer edge pixel, the first image data includes the outer edge pixel having a luminance value set to a value by a predetermined value larger than the data of the image, and
the larger the color difference between the outer edge pixel and the outer peripheral pixel in the data of the image is, or the larger the saturation of the outer edge pixel in the display image data is, the larger the predetermined value is.

2. The display system according to claim 1, wherein
the first image data generation section performs the first image data generation process if a luminance difference calculated in the outer edge pixel in the data of the image is smaller than a reference value.

3. A display program adapted to display an image, making a computer function as a system comprising:
a first image data generation section adapted to perform a first image data generation process of generating first image data from data of the image;
a second image data generation section adapted to generate second image data obtained by performing area coverage modulation on the first image data; and
a display processing section adapted to perform a process of making an electronic paper display the image based on the second image data,
wherein assuming that an outer edge pixel is a pixel in an outer edge of a figure included in the data of the image, and an outer peripheral pixel is a pixel located outside the figure and adjacent to the outer edge pixel, the first image data includes the outer edge pixel having a luminance value set to a value by a predetermined value larger than the data of the image, and
the larger the color difference between the outer edge pixel and the outer peripheral pixel in the data of the image is, or the larger the saturation of the outer edge pixel in the display image data is, the larger the predetermined value is.

4. The display program according to claim 3, wherein
the first image data generation section performs the first image data generation process if a luminance difference calculated in the outer edge pixel in the data of the image is smaller than a reference value.

5. A display method adapted to display an image, comprising:
performing a first image data generation process of generating first image data from data of the image;
generating second image data obtained by performing area coverage modulation on the first image data; and
performing a process of making an electronic paper display the image based on the second image data,
wherein assuming that an outer edge pixel is a pixel in an outer edge of a figure included in the data of the image, and an outer peripheral pixel is a pixel located outside the figure and adjacent to the outer edge pixel, the first image data includes the outer edge pixel having a luminance value set to a value by a predetermined value larger than the data of the image, and
the larger the color difference between the outer edge pixel and the outer peripheral pixel in the data of the image is, or the larger the saturation of the outer edge pixel in the display image data is, the larger the predetermined value is.

6. The display method according to claim 5, wherein
in the performing of the first image data generation process, the first image data generation process is performed if a luminance difference calculated in the data of the image is smaller than a reference value.
